(19) United States
(12) Patent Application Publication
(10) Pub. No.: US 2010/0030691 A1
(43) Pub. Date: Feb. 4, 2010

(54) DURING AN E-COMMERCE TRANSACTION SENDING A POSTAL PACKAGE TO A RECIPIENT BASED UPON A RECIPIENTS EMAIL ADDRESS

(75) Inventors: ULYSSES LAMONT CANNON, DURHAM, NC (US); RUTHIE D. LYLE, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/184,828

(22) Filed: Aug. 1, 2008

(51) Int. Cl. G06Q 30/00

(52) U.S. Cl. 705/50; 705/1; 705/27

(57) ABSTRACT

An e-commerce transaction can be identified that includes at least one item to be shipped to a postal address of a recipient. A user interface involved in the e-commerce transaction can prompt for an email address. An email address can be received as an address for the recipient. A postal address can be programmatically determining by querying a data store using the email address as a recipient identifier. A shipment of the at least one item can be initiated to the determined postal address.

### BACKGROUND OF THE INVENTION

The present invention relates to the field of e-commerce and shipping, more particularly to sending a postal package to a recipient based upon a recipient's email address.

E-mail has become an increasing popular communication mechanism relative to postal mail. It is also becoming increasingly common for a person to have another person's email address and not their postal address. For example, long time acquaintances communicating through a social networking forum often exchange email messages, but know little other personal information concerning the other person. In many instances this anonymity is highly prized. A person possessing an email address of another can desire to send that person an item purchased through an e-commerce site, which must be shipped via postal mail. At present, the recipient must provide the sender their postal address, which is problematic in terms of breaking anonymity and in circumstances where the sender wanted to surprise the recipient with a gift.

### BRIEF DESCRIPTION OF THE SEVERAL VIEWS OF THE DRAWINGS

FIG. 1 is a schematic diagram of a system for using an email address as the shipping address for a postal package in accordance with an embodiment of the inventive arrangements disclosed herein.

FIG. 2 illustrates sample interfaces for using an email address as the shipping address for a postal package in accordance with an embodiment of the inventive arrangements disclosed herein.

FIG. 3 is a flow chart of a method for using an email address as the shipping address for a postal package in accordance with an embodiment of the inventive arrangements disclosed herein.

### DETAILED DESCRIPTION OF THE INVENTION

The present invention can allow the shipment of postal packages to an email address, even when a postal address is unknown by a sender. The present invention can allow a user to only specify a recipient's e-mail address as a shipping address when making a purchase. During this transaction, the e-commerce site from which a purchase is made can purposely omit recipient identifying data from the sender. This protects the recipient's privacy, while permitting a means to send items through postal mail, when only an email address is known. Even when other identifying information is known, the solution can be beneficial since it doesn't require an e-commerce shopper to transmit personal information, such as a postal address, over what may be an unsecure communication channel. Further, omitting postal details of a shipment address from a user interface prevents bystanders physically proximate to an e-commerce user from seeing the postal address, which would typically be displayed on a monitor.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

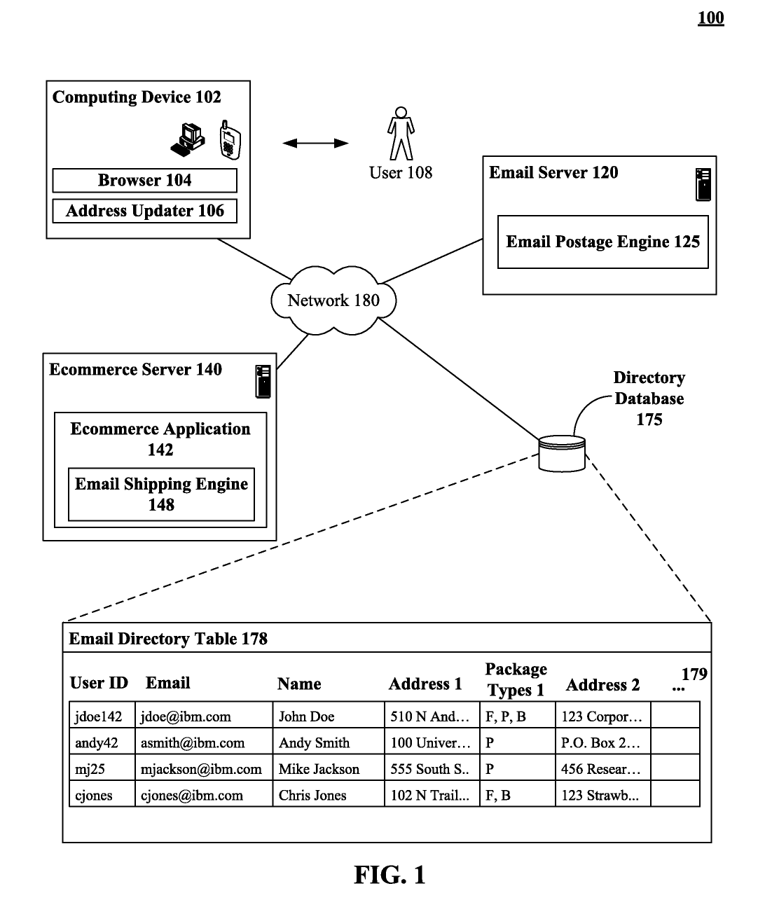

FIG. 1 is a schematic diagram of a system 100 for using an email address as the shipping address for a postal package in accordance with an embodiment of the inventive arrangements disclosed herein. In system 100, computing device 102 can be used by user 108 to interact with e-commerce server 140 and email shipping engine 125. User 108 can configure postal addresses associated with their email address using address updater 106. User 108's configuration settings and associated email addresses can be saved in directory database 175, as illustrated by email directory table 178.

Email directory table 178 illustrates how data can be stored in directory database 175. Email directory table 178 includes fields for: user ID, email, name, address 1, package types 1, and address 2. Email directory table 178 also includes ellipsis 179, which is shown to illustrate that email directory table 178 can store any number of postal addresses and a configuration for each. In table 178, the user ID field can be used to store the user identifier for the user who owns the record. The email field can be used to store the email address which is being associated with postal addresses. The name field can be used to store the full name of the user. The address 1 field can be used to store a postal address to associate with the email address. Package types 1 can hold a configuration relating to address 1. For every address field after what is shown, there can be a field for package type to store associated configuration. The table 178 specifics are for illustrative purposes only and are not to be construed as a limitation of the scope of the invention described herein.

Once email addresses have been associated with postal addresses for e-commerce purposes, user 108 can browse a set of products hosted in e-commerce application 142. A user 108 of browser 104 can opt to purchase an item from the e-commerce application 142 that requires postal shipping. During a transaction checkout process, user 108 can be prompted for the address in which the order should be shipped. At this point, user 108 can provide an email address of a desired recipient. This can be an email address already stored in directory database 175.

The directory database 175 can be associated directly with e-commerce server 140, can be associated with an email server 120, and or can be associated with a different network entity (i.e., an entity providing an email-to-postal lookup Web service, for example). Security measures can be implemented by an entity/computing system maintaining the directory database 175.

To elaborate, assume an embodiment, where email server 120 maintains records of database 175. In this embodiment, email shipping engine 148 can contact email postage engine 125 requesting postal addresses associated with the email address. Authentication information can be optionally transferred with the request. Further, in one implementation e-commerce specific data can be conveyed at this time, which engine can utilize to select a preferred shipping address for a given transaction in situations where multiple different postal addresses are associated with an email address. During processing, email postage engine 125 can consult directory database 175 to determine valid postal addresses to convey to email shipping engine 148. Email postage engine 125 can convey a response to the email shipping engine 148. The response can include a postal address, an authentication denial response, a postal address not found response, and the like. Assuming a postal address is received by the server 140, shipping actions to the discovered postal address (associated with the user 108 entered email address) can be taken.

As shown herein, computing device 102 can be any device through which a user 108 can conduct e-commerce transactions. Computing device 102 can include a browser 104 and/or address updater 106. Browser 104 can be a software application granting access to the e-commerce server 140. Address updater 106 can be an interactive software application that permits a user 108 to make configuration changes relating to shipping addresses linked to email addresses. The user 108 can, for example, use updater 106 to adjust shipment preferences, address details, and the like. The computing device 102 can include a personal computer, a mobile phone, a kiosk, and the like.

Email server 120 can be any computing system able to facilitate email conveyances. The email server 120 can leverage its internal records of its email users, to provide the email-to-postal address look-up functionality. Other types of servers, including the e-commerce server 140 itself, can maintain data (in data store 175) to enable the email-to-postal address look-up functionality.

E-commerce server 140 can be any computing device configured to host an e-commerce application 142 and/or to interact with an e-commerce application such that shipping details for purchased items can be specified. For example, many online payment artifacts (e.g., PAYPAL, GOOGLE CHECK-OUT, etc.) exist that provide addresses to e-commerce servers 140 during a check-out process.

Directory database 175 can be physically implemented within any type of hardware including, but not limited to, a magnetic disk, an optical disk, a semiconductor memory, a digitally encoded plastic memory, a holographic memory, or any other recording medium. The directory database 175 can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 180 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 180 can include local components and data pathways necessary for communications to be exchanged among computing device components and between integrated device components and peripheral devices. The network 180 can also include network equipment, such as routers, data lines, hubs, and intermediary servers which together form a packet-based network, such as the Internet or an intranet. The network 180 can further include circuit-based communication components and mobile communication components, such as telephony switches, modems, cellular communication towers, and the like. The network 180 can include line based and/or wireless communication pathways.

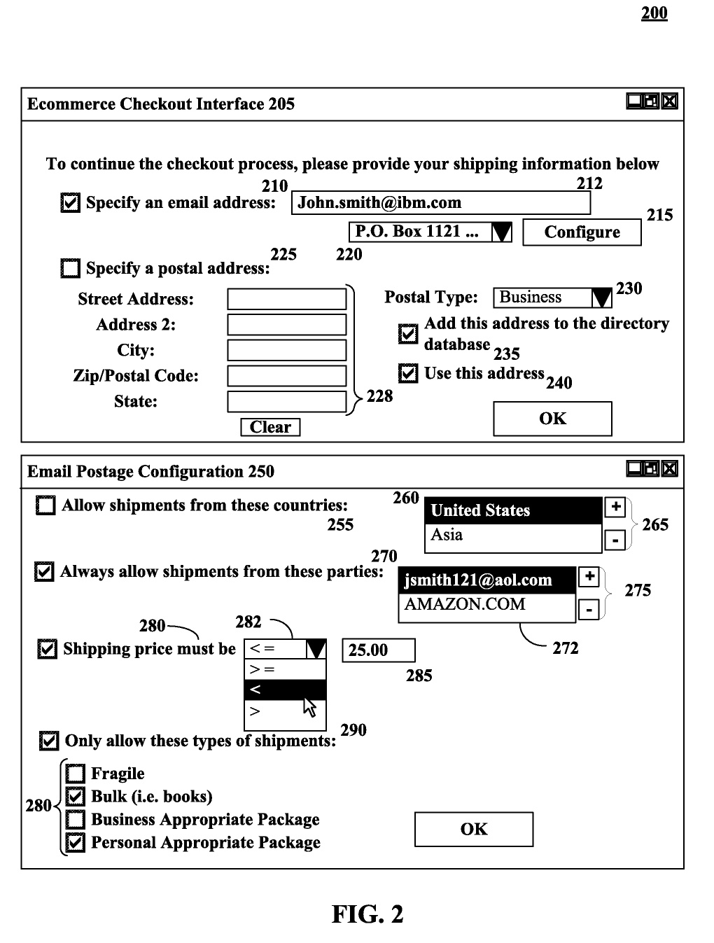

FIG. 2 illustrates sample interfaces 205, 250 for using an email address as the shipping address for a postal package in accordance with an embodiment of the inventive arrangements disclosed herein. In one embodiment, the interfaces 205, 250 can be interfaces presented by device 102 to user 108.

Interface 205 is an e-commerce checkout interface presented at a point in an e-commerce order process where the shipment information is to be entered. Interface 205 allows a user to specify an email address as a shipment address.

E-commerce checkout interface 205 can include email address option 210. When enabled, email address 210 can enable the usage of an email address entered into control 212 to look up associated postal addresses. Control 215 can be a button which can allow a user to jump to an email postage configuration interface, such as interface 250. Control 220 can be a pull-down control, which can automatically be populated with postal addresses associated with the email address entered in control 212. Control 225 can enable specifying a postal address using controls 228. In interface 205, controls 228 have been pre-populated with the information associated with the postal address selected in control 220. Control 230 can allow the user to select allowed postal types. Such postal types can include freight, business, personal, fragile, a combination thereof, and the like. Control 235 can allow the user to specify saving the address specified in controls 228 to the postage directory database. Control 240 can allow the user to enable the use of the address typed into controls 228.

Interface 205 is only one sample implementation of an e-commerce checkout interface. E-commerce checkout interface 205 can be implemented in any fashion and include the ability to enter an email address as a shipping address. In some embodiments, the e-commerce application may not receive the postal address, and therefore not display it for the user. An embodiment such as this can be implemented for example, by forwarding the postal address and shipment information to a postal carrier (i.e., FEDEX, UPS) and automatically generate a coded label (without the postal address) for the party sending the shipment. The label can be used to ship the package, and the information coded on the label can allow the postal carrier to determine the destination address. Other embodiments can employ this solution when an e-commerce application is not involved. For example, an internet user wants to send a package to another internet user, but they only know the recipient's email address.

Interface 250 is an email postage configuration interface permitting an arbitrary level of control for configuring email postal shipments. Interface 250 can include control 255, which when enabled can be associated with controls 260 and 265. When control 255 is enabled, the countries in which shipments are allowed can be restricted to the countries listed in control 260. Controls 265 can be used to add or delete countries from the list. Control 270 can always allow shipments from people or companies listed in control 272. Controls 275 can be used to add or remove parties listed in control 272. Control 280 can be used to require the shipping cost to be within a certain range. Control 282 can be a pull-down which can be used to select a conditional operator, such as greater than, less than, greater than or equal to, and the like. Control 285 can be a control used to specify a numerical value. When enabled, option 280 can restrict the shipping price to be the logical condition selected in 282 (for example, less than) the numerical value entered in control 285. Control 290 can be used to specify which types of shipments can be allowed. Controls 280 can be used to enable each different kind of postal package type. Postal package types can include any package type, including, but not limited to, fragile, bulk, business, personal, and the like.

The configuration options shown in interface 250 are suggested options that can be applied in any way. For example, one, all, or a combination of these settings can be used to be applied to all shipments for the email address. These settings can also be applied to different postal addresses associated with an email address. In another example, settings can be applied to certain kinds of shipments. It is contemplated that an interface can be used to create rules for different combinations of package types, prices, country of origin, sender, and the like. For example, a user could specify that if a package is a bulk package, the shipping price must cost less than 50, and must come from inside the United States. Making combinations of rules using settings such as these can allow the user to fully customize the handling of postal packages sent to their email address.

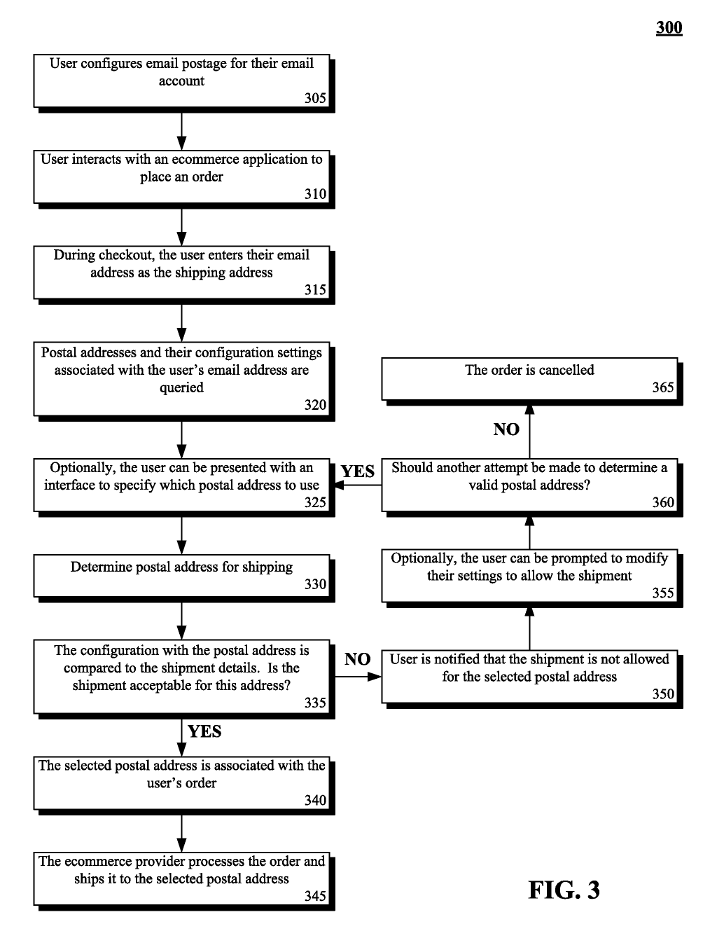

FIG. 3 is a flow chart of a method 300 for using an email address as the shipping address for a postal package in accordance with an embodiment of the inventive arrangements disclosed herein. Method 300 can be performed in context of system 100 and can begin in step 305, where a user can configure email postage for their email account. This can include associating a plurality of postal addresses with their email addresses, and configuring a set of restrictions for each. In step 310, the user can interact with an e-commerce application to place an order. In step 315, during checkout, the user can enter a recipient's email address as the shipping address. In step 320, the postal addresses and their configuration settings associated with the recipient's email address are queried.

In step 325, the user can optionally be presented with an interface to specify which postal address to use, should multiple addresses be associated with an email address. In one embodiment, specific details of the postal address can be hidden, yet the user can be presented with a set of options permitting a program to decide with of a set of possible postal addresses is to be used. For example, options such as work address, home address, and the like can be shown without actually displaying a postal address.

In step 330, the postal address that is to be used for shipping an item can be determined. In step 335, the postal address' configuration can be compared to the shipment details and it can be determined if the shipment is acceptable for the selected address. If in step 335, the shipment is acceptable for the selected address, method 300 can continue to step 340, where the selected postal address is associated with the user's order. In step 345, the e-commerce provider processes the order and ships it to the selected postal address.

If in step 335, the postal address's configuration conflicts with the shipment details, method 300 can continue to step 350, where the user can be notified that the shipment can't be shipped to the postal address. In step 355, the user can optionally be prompted to modify their email postage settings to allow the shipment. In step 360, it can be determined if another try should be attempted to select a valid postage address. If in step 360, it is determined another attempt should not be made, method 300 can complete in step 365, where the order can be cancelled. If in step 360, another attempt should be made to determine a valid postal address, method 300 can return to step 325, where the user can optionally be presented with an interface to specify which postal address to use. It is contemplated that in this case, method 300 can loop until a valid postal address is selected, or until no more attempts should be made at determining a valid postal address.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for shipping a postal package comprising:
identifying an e-commerce transaction that includes at least one item to be shipped to a postal address of a recipient;
prompting via a user interface involved in the e-commerce transaction for an email address;
receiving an email address as an address for the recipient;
programmatically determining a postal address by querying a data store using the email address as a recipient identifier; and
initiating a shipment of the at least one item to the determined postal address.

2. The method of claim 1, further comprising:
programmatically ensuring that no user interface involved in the e-commerce transaction presents the determined postal address.

3. The method of claim 2, further comprising:
programmatically ensuring that no user interface involved in the e-commerce transaction presents identifying information related the recipient excluding identifying information related to the recipient that has been input by a user of the user interface.

4. The method of claim 1, wherein the recipient is an individual other than a user of the user interface and has a different postal address than a postal address associated with the user of the user interface.

5. The method of claim 1, further comprising;
conveying a postal address request from the e-commerce server to the email server associated with the received email address, wherein the postal address request comprises at least the received email address, wherein the queried data store is a data store that is associated with the email server; and
conveying the postal address from the email server to the e-commerce server.

6. The method of claim 5, wherein the postal address request comprises an authentication key, said method further comprising:
providing the postal address to the e-commerce server only when the authentication key indicates that the e-commerce server is authorized to receive the postal address.

7. The method of claim 3, further comprising;
maintaining user information within a data store for the e-commerce store associated with the e-commerce transaction, wherein the data store comprises records associated with registered users of the e-commerce store, wherein for each user, the records comprise an email address associated with the registered user and at least one postal address for the registered user, wherein the recipient is a registered user of the e-commerce store, and wherein the queried data store is the data store for the e-commerce store.

8. The method of claim 1, further comprising:
conveying a postal address request from the e-commerce server to the remotely located network server independent of the e-commerce server, wherein the postal address request comprises at least the received email address and details specific to the e-commerce transaction;
identifying a plurality of postal addresses associated with the received email address when querying the data store; and
determining one of the plurality of postal address for shipping the at least one item based at least in part upon the details specific to the e-commerce transaction.

9. A computer program product for shipping a postal package comprising:
a computer usable medium having computer usable program code embodied therewith, the computer usable program code comprising:
computer usable program code configured to identify an e-commerce transaction that includes at least one item to be shipped to a postal address of a recipient;
computer usable program code configured to prompt via a user interface involved in the e-commerce transaction for an email address;
computer usable program code configured to receive an email address as an address for the recipient;
computer usable program code configured to programmatically determine a postal address by querying a data store using the email address as a recipient identifier; and
computer usable program code configured to initiate a shipment of the at least one item to the determined postal address.

10. The computer program product of claim 9, further comprising:
computer usable program code configured to programmatically ensure that no user interface involved in the e-commerce transaction presents the determined postal address.

11. The computer program product of claim 10, further comprising:
computer usable program code configured to programmatically ensure that no user interface involved in the e-commerce transaction presents identifying information related the recipient excluding identifying information related to the recipient that has been input by a user of the user interface.

12. The computer program product of claim 9, wherein the recipient is an individual other than a user of the user interface and has a different postal address than a postal address associated with the user of the user interface.

13. The computer program product of claim 9, further comprising;
computer usable program code configured to convey a postal address request from the e-commerce server to the email server associated with the received email address, wherein the postal address request comprises at least the received email address, wherein the queried data store is a data store that is associated with the email server; and
computer usable program code configured to convey the postal address from the email server to the e-commerce server.

14. The computer program product of claim 13, wherein the postal address request comprises an authentication key, said computer program product further comprising:
computer usable program code configured to provide the postal address to the e-commerce server only when the authentication key indicates that the e-commerce server is authorized to receive the postal address.

15. The computer program product of claim 11, further comprising;
computer usable program code configured to maintain user information within a data store for the e-commerce store associated with the e-commerce transaction, wherein the data store comprises records associated with registered users of the e-commerce store, wherein for each user, the records comprise an email address associated with the registered user and at least one postal address for the registered user, wherein the recipient is a registered user of the e-commerce store, and wherein the queried data store is the data store for the e-commerce store.

16. The computer program product of claim 9, further comprising:
computer usable program code configured to convey a postal address request from the e-commerce server to the remotely located network server independent of the e-commerce server, wherein the postal address request comprises at least the received email address and details specific to the e-commerce transaction;
computer usable program code configured to identify a plurality of postal addresses associated with the received email address when querying the data store; and
computer usable program code configured to determine one of the plurality of postal address for shipping the at least one item based at least in part upon the details specific to the e-commerce transaction.

17. An e-commerce web site comprising:
a check out interface for purchasing items from an e-commerce store;
a shipping interface comprising an input interface control for specifying a recipient email address as an address to which an item purchased using the check out interface is to be shipped through postal mail, wherein the check out interface and the shipping interface are configured to never display a postal address to which the item is to be shipped.

18. The e-commerce web site of claim 17, wherein the check out interface and the shipping interface are configured to never display identifying information related to the recipient excluding identifying information provided as input to the check-out interface and to the shipping interface.
